(19) United States
(12) Patent Application Publication
(10) Pub. No.: US 2009/0027752 A1
(43) Pub. Date: Jan. 29, 2009

(54) PROJECTION DISPLAY APPARATUS FOR REMOVING NOISE

(75) Inventors: Chang-Su Park, Suwon-si (KR); Dong-Hyun Park, Seoul (KR); Yeong-Gyu Lee, Suwon-si (KR); Jong-Hyeong Song, Suwon-si (KR); Heung-Woo Park, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/111,881

(22) Filed: Apr. 29, 2008

(30) Foreign Application Priority Data
Jul. 25, 2007 (KR) 10-2007-0074351

(51) Int. Cl. G02B 26/00; G02B 27/00

(52) U.S. Cl. 359/237; 359/601

(57) ABSTRACT

A projection type of display apparatus for removing a noise is disclosed. In accordance with an embodiment of the present invention, the projection type of display apparatus includes: a light source; an optical board, incidenting a beam of light emitted from the light source; and an optical modulator, being fixed on one surface of the optical board and modulating and emitting the beam of light that passed through the optical board. The blocking layer is formed on the optical board. With the present invention, it is possible to remove the noise of the image and display the image more clearly by enhancing the contrast.

### CROSS-REFERENCE TO RELATED PATENT APPLICATIONS

This application claims the benefit of Korean Patent Application No. 10-2007-0074351, filed on Jul. 25, 2007, in the Korean Intellectual Property Office, the disclosure of which is incorporated herein in its entirety by reference.

### BACKGROUND OF THE INVENTION

1. Field of the Invention

The present invention relates to a projection type of display apparatus, more specifically to a display apparatus for removing a noise that can be produced in a projection type of display apparatus.

2. Background Art

In a conventional projection type of display apparatus, a beam of light emitted from a light source is not only emitted to an actual area forming an image but emitted to a dummy area, which is unnecessary to form the image. So, the beam of light emitted to the dummy area produces a noise that is unnecessary for the image.

Referring to FIG. 1, the reason for a noise generated in a display apparatus will be described below. FIG. 1 is an example showing a conventional projection type of display apparatus and the image displayed through this apparatus.

A light source 110 emits a beam of light to an optical board 120. An incidental beam forms an image on a screen 150 through an optical modulator 130. The beam of light needs to be emitted to a part of the optical modulator 130 only to display the image on the screen 150.

However, the width of the beam of light emitted from the light source used in the display apparatus is greater than the length of the optical modulator 130, and thus the beam of light is emitted to a dummy area 140, which is not an actual area 160, which is a part of length of optical modulator. Hereupon, the displayed image includes not only the image 170 necessary for the screen 150 but also an unnecessary noise 180

As such, since the beam of light emitted from the light source 110 is also emitted to the unnecessary dummy area 140, a contrast value becomes lower than when the actual area 160 is emitted only and the noise is produced, making it difficult for a user to see a clear image.

### SUMMARY OF THE INVENTION

Accordingly, the present invention provides a display apparatus to remove a noise that can be produced in a conventional projection type of display apparatus.

The present invention also provides a clearer image by enhancing the contrast of a displayed image.

Also, the present invention provides a display apparatus having a high align accuracy by using a semiconductor process during a process of building an apparatus for removing a noise.

An aspect of the present invention features projection type of display apparatus for removing noise. Projection type of display apparatus for removing noise, includes a light source; an optical board, incidenting a beam of light emitted from the light source; and an optical modulator, being fixed on one surface of the optical board and modulating and emitting the beam of light that passed through the optical board, wherein a blocking layer is formed on the optical board.

And, wherein the blocking layer can be located on a dummy area of the optical board, and the dummy area can be an area on the optical board where the beam of light emitted from the light source can be incidented, excluding an area where the optical modulator can be located.

Also, the blocking layer may have a low reflectance and the blocking layer can be a multilayer film of metal and metal oxide on the optical board. And the blocking layer can be a pattern of polymer formed on the optical board and, the polymer can be made of one from the group consisting of black PR, photo resist and polymid.

Also, the blocking layer can diffuse-reflect the beam of light emitted from the light source, and can be a sanding pattern formed on the optical board and can be formed by adding a pattern through a laser processing on the optical board.

Here, the blocking layer can be formed on one surface of the optical board, and the one surface of the optical board can be a surface on which the optical modulator can be located and the blocking layer being formed on the one surface of the optical board can be formed by a semiconductor process.

And, the blocking layer can be formed on the other surface of the optical board, and the other surface of the optical board can be an opposite surface of where the optical modulator can be located and the blocking layer formed on the other surface of the optical board can be formed after completing an optical module, and the optical module can be a package completed by including the optical modulator on the optical board.

Also, the blocking layer can be non-reflective tape and a hole passing through the optical board can be formed at a location of the optical board corresponding to the optical modulator. And the apparatus further has a cover window, being located on the other surface of the optical board and covering the hole.

And, a phase mediating pattern can be formed on a part of a surface of the cover window, the phase mediating pattern being a path of a beam of light incidenting or emitting to the optical modulator and the phase mediating pattern can be formed in relief and has a height of a compound barker code sequence pattern.

Also, the phase mediating pattern can be formed in intaglio and has a depth of a compound barker code sequence pattern, and the blocking layer can be formed on an upper side and a lower side of the optical modulator located on the optical board.

Here, the blocking layer can be formed in a shape of a rectangle on the optical board and can be formed in a shape of peripheral type with an open center around the optical modulator on the optical board.

### BRIEF DESCRIPTION OF THE DRAWINGS

These and other features, aspects and advantages of the present invention will become better understood with regard to the following description, appended Claims and accompanying drawings where:

FIG. 1 is an example showing a conventional projection type of display apparatus and an image displayed through this apparatus;

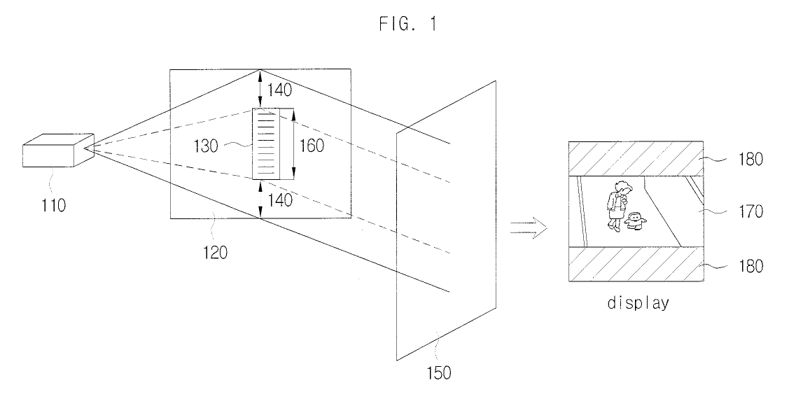

FIG. 2 is an example showing a projection type of display apparatus for removing a noise in accordance with an embodiment of the present invention;

FIG. 3 is a side view of a projection type of display apparatus for removing a noise in accordance with an embodiment of the present invention;

FIG. 4 is a schematic view of a display apparatus for removing a noise using a blocking layer having a low reflectance in accordance with one embodiment of the present invention;

FIG. 5 is a schematic view of a display apparatus for removing a noise using diffuse reflection in accordance with an embodiment of the present invention;

FIG. 6a illustrates an example showing an optical board to which a multilayer pattern of a metal or metal oxide is added on one surface of the optical board;

FIG. 6b illustrates an example showing an optical board in which a blocking layer is formed on the other surface of the optical board;

FIG. 7a illustrates an example of an optical module in which a blocking layer is located on one surface of an optical board in accordance with one embodiment of the present invention;

FIG. 7b illustrates an example of an optical module in which a blocking layer is located on the other surface of the optical board in accordance with one embodiment of the present invention;

FIG. 7c illustrates an example of an optical module in which a cover window is located on the other surface of the optical board in accordance with one embodiment of the present invention;

FIG. 8a illustrates an example of an optical board on which a peripheral type of blocking layer, the center of which is opened, is located on the optical board; and

FIG. 8b illustrates an example of an optical board, in which a blocking layer is located on an upper and lower side of the optical board.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings.

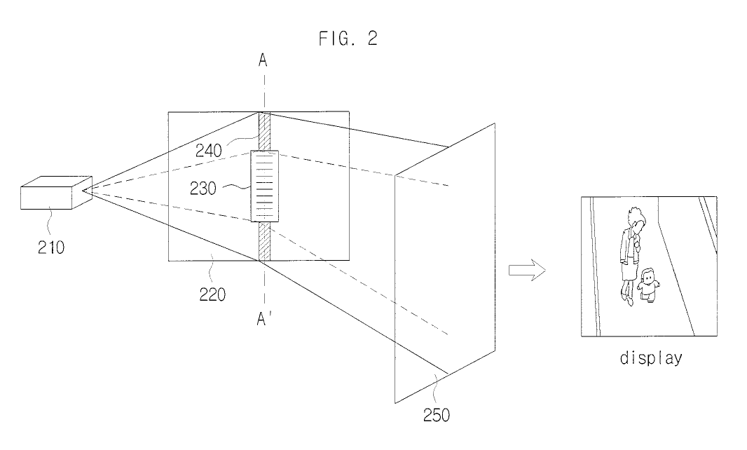

Hereinafter, referring to FIG. 2, the construction of a projection type of display apparatus for removing a noise in accordance with an embodiment of the present invention will be described. FIG. 2 is an example showing a projection type of display apparatus for removing a noise in accordance with an embodiment of the present invention.

A light source 210 emits a beam of light to an optical board 220. The beam of light emitted to an optical board 220 allows the image to be displayed on a screen 250 through an optical modulator 230. A conventional display apparatus does not include a blocking layer 240, and thus a noise is displayed due to the beam of light emitted to a dummy area 140, as described above. In accordance with the present invention, however, this problem can be solved by locating the blocking layer 230 on the optical board 220.

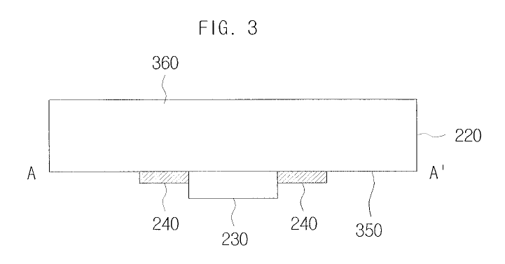

Hereinafter, referring to FIG. 3, locations of the optical modulator and blocking layer are described in the projection type of display apparatus for removing a noise in accordance with an embodiment of the present invention. FIG. 3 is a side view of the projection type of display apparatus for removing a noise in accordance with an embodiment of the present invention that is viewed along the A-A′ surface of the display apparatus of FIG. 2

A beam of light is incidented from the light source 210 to the optical board 220. An incidented beam of light goes to the optical modulator 230 and the modulated beam of light diffracted or reflected in the optical modulator 230 makes an image to be displayed on the screen. Hereinafter, a part of the optical board 220 in which the optical modulator 230 is located will be referred to as one surface 350 of the optical board 220, and the opposite side of the one side 350 will be referred to as an other surface 360 of the optical board 220. According to an embodiment of the present invention, a beam of light is incidented to the other surface 360 of the optical board 220.

On the one surface 350 of the optical board 220, the blocking layer 240 is located on upper and lower sides along the length of the optical modulator 230, and a noise in the displayed image is removed by the blocking layer 240.

There are two main principles of removing the noise by locating a blocking layer. First, a blocking layer is made of a material having a low reflectance and, second, the beam of light incidented to the blocking layer is diffuse-reflected.

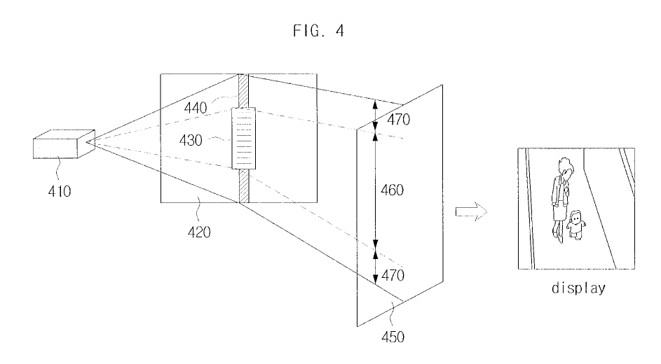

Referring to FIG. 4, the principle of removing the noise by making the blocking layer with a material having a low reflectance will be described. FIG. 4 is a schematic view of a display apparatus for removing a noise using a blocking layer having a low reflectance in accordance with one embodiment of the present invention.

A beam of light is incidented from a light source 410 to an optical board 420. Here, the beam of light incidented to an optical modulator 430 located in one surface of the optical board modulates to reflect or deflect, and the modulated beam of light makes an image to be display on a screen 450. At this time, a blocking layer 440 having a low reflectance is located on one surface of the optical board 420 for removing a noise in accordance with one embodiment.

It is apparent here that the blocking layer 440 having a low reflectance also has a low transmissivity. That is, the beam of light passing through the blocking layer 440 is not reflected or transmitted, and most of the beam of light passing through the blocking layer 440 is absorbed to the blocking layer 440. Therefore, the blocking layer 440 having a low reflectance means that the blocking layer 440 also has a low transmissivity.

The beam of light incidented from the light source 410 is displayed only when the beam of light passes through an actual area 460 necessary for displaying a real image, that is, only the beam of light passing through the optical modulator 430 is displayed on the screen 450.

Formed with a material having a low reflectance, the blocking layer 440 can be polymer, metal or metal oxide. Polymer is a compound produced by the polymerization of molecules and can be one of black PR, polymid and photo resist.

Most of the beam of light incidented from the light source 410 to the blocking layer 440 having a low reflectance can not be reflected and thus is not displayed on the screen 450. That is, part of the beam of light emitted from the light source 410 is not reflected and thus can not be projected to the screen 450, by adding the blocking layer 440 on the one surface of the optical board 420.

Through this, the noise produced by the beam of light reflected on a dummy area 470, which is unnecessary for displaying, is removed and makes only the beam of light passing through the actual area 460 necessary for displaying display on the screen 450.

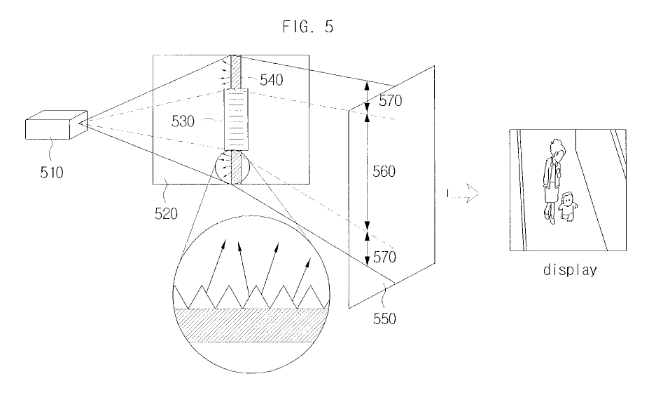

Hereinafter, referring to FIG. 5, a display apparatus removing noises of the image by letting a beam of light incidented from a light source 510 to diffuse reflect is described. FIG. 5 is a schematic view of a display apparatus for removing noises using diffuse reflection in accordance with an embodiment of the present invention.

A beam of light is incidented from a light source 510 to an optical board 520. The incidented beam is modulated to reflect or diffract on the optical modulator 530. And the modulated beam makes the beam of light display an image on a screen 550. At this time, a blocking layer 540 making the beam of light incidented from the light source 510 to diffuse-reflect is located on the optical board 520.

Diffuse reflection is reflection of light from an uneven or granular surface such that an incident ray is seemingly reflected at a number of angles. Therefore, a beam of light passing through the optical modulator 530 from among the beam of light incidented from the light source 510 to the optical board 520 is displayed as an image on the screen 550 and the beam of light incidented to the blocking layer 540 is diffuse reflected, and the beam of light can not proceed to the screen 550 or form the image on the screen 550 by reflecting to all directions.

That is, because the surface of the blocking layer 540 is rough, the incidented beam of light is diffuse-reflected and can not proceed to the screen 550 or reflect all directions, so a dummy area 570, which is an unnecessary area, is not displayed. And only the actual area 560, which is an area of light to which the beam of light incidented to the optical modulator 530 is proceeded, is displayed on the screen 550. Therefore, although the dummy area 570, in which a noise is made, is emitted a beam of light, the beam of light proceeds to other directions and is not displayed on the screen 550, removing the noise from the image.

In the display apparatus removing a noise of the displayed image using the principle of diffuse reflection in accordance with one embodiment of the present invention, the blocking layer 540 is made by a sanding process or a laser process. To make the blocking layer 540 using the principle of diffuse reflection, the surface of the blocking layer 540 can be made rough. Then, the beam of light incidented from the light source 510 to the blocking layer 540 is diffuse-reflected and is proceeded to all directions, because the surface of the blocking layer 540 becomes rough by the sanding pattern or the pattern created by the laser process

That is, the beam of light incidented to the optical modulator 530 is reflected or diffracted to display an image on the screen 550, and the area in which the light passes through the optical modulator 530 becomes the actual area 560. As the beam of light incidented to the blocking layer 540 can not proceed to the screen 550 by the diffuse reflection, this results in the same effect as having the beam of light not incidented to the dummy area 570, as described above, displaying a clear image on the screen 550 without any noise.

By adding the blocking layers 440 and 540, the beam of light is incidented to the actual areas 460 and 560, which are necessary for displaying an image, and the same effect as having the beam of light not incidented to the dummy areas 470 and 570 is resulted. Therefore, the noise of the image displayed on the screens 450 and 550 is removed.

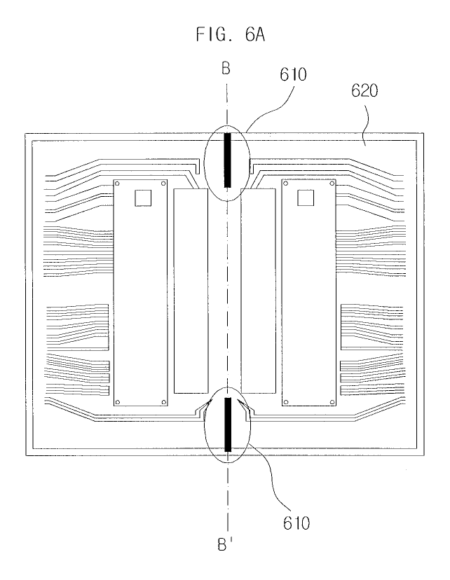

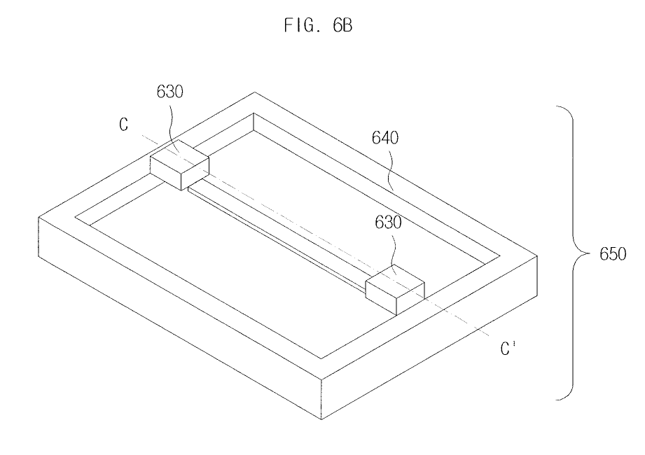

Hereinafter, an optical board on which a blocking layer is placed in accordance with one embodiment of the present invention will be described with reference to FIGS. 6a and 6b.

FIG. 6a is an example showing an optical board to which a multilayer pattern of metal or metal oxide is added on one surface of the optical board.

The blocking layer 610 is located on one surface of the optical board 620. In an embodiment of the present invention, the blocking layer 610 can have a pattern of metal or metal oxide, for example, Cr or CrO₂. This kind of multilayer pattern of metal or metal oxide can lower the reflectance of the blocking layer 610 and prevent a beam of light from incidenting to a dummy area, thereby removing the noise of the image displayed.

Forming the blocking layer 610 on one surface of the optical board 620 can be done during a process of making the optical board 620. If the blocking layer 610 is formed during the process of making the optical board 620, the blocking layer 610 is formed using a semiconductor process and thus can provide a high align accuracy, making it possible to manufacture an optical board used in a more precise display apparatus.

FIG. 6b is an example showing an optical board on which a blocking layer is formed on the other surface of the optical board.

The blocking layer 630 is located on the other surface of the optical board 640. In an embodiment of the present invention, the blocking layer 630 can have a multilayer pattern of metal of metal oxide, as described above, or a pattern of polymer or non-reflective tape. When the blocking layer 630 is located on the other surface of the optical board 640, the same principle as described above of removing noises in the image by lowering the reflectance or using diffuse reflection is used.

Unlike forming the blocking layer 610 on one surface of the optical board 620, the blocking layer 630 can be provided optionally after completing the optical module 650 having the optical board 640 if the blocking layer 630 is formed on the other surface of the optical board 640. The optical module 650 refers to a complete package including an optical board 640, an optical modulator located on the optical board 640, and a driver IC for driving these.

Unlike forming the blocking layer 610 on one surface of the optical board 620, it is difficult to expect a high align accuracy because the semiconductor process can not be used if the blocking layer 630 is formed after completing the optical module 650. As such, in case of forming the blocking layer 630 optionally after the completion of the optical module 650, the align accuracy is lower than using a semiconductor process because the blocking layer 630 is optionally formed manually.

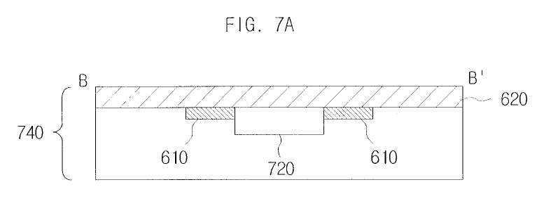

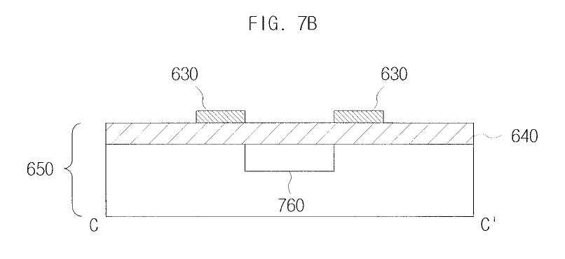

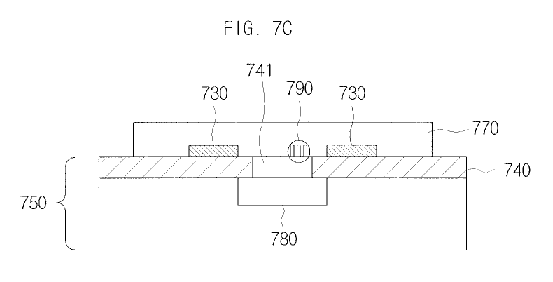

Hereinafter, forming a blocking layer on one surface of an optical board and forming a blocking layer on the other surface of an optical board will be described with reference to FIGS. 7a and 7b.

FIG. 7a is an example showing an optical module 740 with a blocking layer located on one surface of the optical board in accordance with an embodiment of the present invention. FIG. 7a shows a view along B-B′ of FIG. 6a.

An optical modulator 720 is located on one surface of the optical board 620. And, the blocking layer 610 is located on upper and lower sides along the length of the optical modulator. As such, the optical modulator 740 completed by including the optical board 620, the optical modulator 720 and the blocking layer 610 constitutes a display apparatus.

FIG. 7b is an example showing an optical module with a blocking layer located on the other surface of the optical board in accordance with an embodiment of the present invention. FIG. 7b shows a view along C-C′ of FIG. 6b.

An optical modulator 760 is located on one surface of the optical board 640. And, the blocking layer 630 is located on the other surface, which is the opposite surface of the one surface located an the optical modulator 760. When the blocking layer 630 is located on the other surface, the blocking layer 630 is formed after the completion of the optical module 650. The blocking layer can be the one of non-reflective tape, metal or metal oxide. Because the blocking layer 630 formed on the other surface of the optical board 640 is placed after the completion of the optical module 650, it has a lower align accuracy than using a semiconductor process.

FIG. 7c is an example showing an optical module with a cover window and a blocking layer located on the other surface of the optical board in accordance with an embodiment of the present invention.

An optical modulator 780 is located on the one surface of an optical board 740. Similar to FIG. 7b described above, a blocking layer 730 is located on the other surface of the optical board 740. A hole 741 passing through the optical board 740 is formed at a location of the optical board 740 corresponding to the optical modulator 780. That is, the hole 741 passing through the optical board 740 is formed on a part of the optical board 740 corresponding to the location of the optical modulator 780. This hole 741 makes a beam of light incidented to the optical modulator 780 more effectively and emitted from the optical modulator 780 more effectively.

When the hole 741 is formed on the optical board 740 as described above, the optical module 750 can also have a cover window 770 for covering the hole 741 on the other surface of the optical board 740 in accordance with an embodiment of the present invention, in order to prevent any erroneous operation of the optical modulator 780 caused by fine dust. As described above, the cover window 770 can be formed on the blocking layer 730 located on the other surface of the optical board 740. The optical module 750 in which the cover window 770 is formed on the blocking layer 730 located on the other surface of the optical board 740 has the following differences from the optical module 650 shown in FIG. 7b.

The blocking layer 630, located on the other surface of the optical board 640 illustrated in FIG. 7b, is formed on the other surface of the optical board 640 after the completion of the optical module 650. However, the blocking layer 730, located on the other surface of the optical board 740 illustrated in FIG. 7c, is formed before the completion of the optical module 750. That is, the cover window 770 is formed after the blocking layer 730 is completely formed to complete the optical module 750.

Here, a phase mediating pattern 790 can be formed on a part of the surface of the cover window 770 that is a path of a beam of light incidenting or emitting to the optical modulator 780. The phase mediating pattern 790 can be formed in intaglio, and a phase variation of a beam of light incidented or emitted is induced according to the depth of the phase mediating pattern 790. The depth can be the same as the height of a compound barker code sequence pattern.

It is also possible that the phase mediating pattern 790 is formed in relief, and a phase variation of a beam of light incidented or emitted is induced according to the height of the phase mediating pattern 790. The height can be the same as the height of a compound barker code sequence pattern. By this phase mediating pattern 790, an image with a reduced speckle can be obtained. Since the process of speckle reduction through the phase mediating pattern 790 is apparent to one having ordinary skill in the art, the description will be omitted herein.

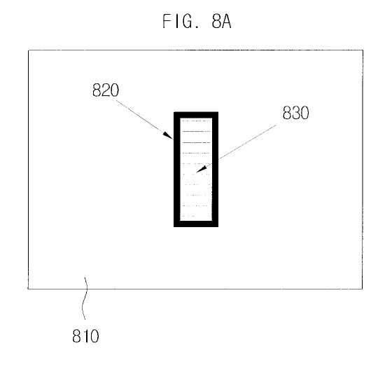

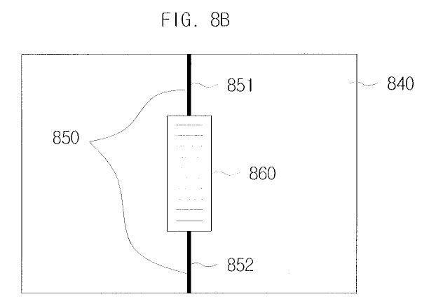

Hereinafter, a shape of a blocking layer located on an optical board in accordance with an embodiment of the present invention will be described with reference to FIGS. 8a and 8b. FIG. 8a is an example showing an optical board on which a blocking layer 820 of a peripheral type with the center open is located.

Because the blocking layer 820 is located in a shape of a rectangle on the optical board 810, a beam of light incidented to the blocking layer 820, which is a beam of light incidented to a dummy area, is not displayed along the length or the width, and the beam of light incidented to the optical modulator 830 is displayed on the screen.

FIG. 8b is an example of the optical board on which a blocking layer 850 is located. By forming the blocking layer 850 on the upper side 851 and lower side 852 along the length of an optical modulator 860, a beam of light incidented can display an actual area only, in which an optical modulator 860 is located, excluding a dummy area in which a blocking layer 850 is located, thereby removing the noise of the image.

That is, the blocking layer in the optical board is made of a material having a low reflectance regardless of the shape, and thus the noise of an image is removed by making the dummy area not display any image or by making a beam of light to be diffuse-reflected. Moreover, regardless of the shape, the blocking layer can be formed on one surface of the optical board or the other surface of the optical board after the completion of the optical module.

Hitherto, although some embodiments of the present invention have been shown and described, it will be appreciated by any person of ordinary skill in the art that a large number of modifications, permutations and additions are possible within the principles and spirit of the invention, the scope of which shall be defined by the appended claims and their equivalents.

What is claimed is:

1. A projection type of display apparatus for removing a noise, comprising,
a light source;
an optical board, incidenting a beam of light emitted from the light source; and
an optical modulator, being fixed on one surface of the optical board and modulating and emitting the beam of light that passed through the optical board,
wherein a blocking layer is formed on the optical board.

2. The apparatus of claim 1, wherein the blocking layer is located on a dummy area of the optical board, and
the dummy area is an area on the optical board where the beam of light emitted from the light source is incidented, excluding an area where the optical modulator is located.

3. The apparatus of claim 1, wherein the blocking layer has a low reflectance.

4. The apparatus of claim 3, wherein the blocking layer is a multilayer film of metal and metal oxide on the optical board.

5. The apparatus of claim 3, wherein the blocking layer is a pattern of polymer formed on the optical board.

6. The apparatus of claim 5, wherein the polymer is made of one from the group consisting of black PR, photo resist and polymid.

7. The apparatus of claim 1, wherein the blocking layer diffuse-reflect the beam of light emitted from the light source.

8. The apparatus of claim 7, wherein the blocking layer is a sanding pattern formed on the optical board.

9. The apparatus of claim 7, wherein the blocking layer is formed by adding a pattern through a laser processing on the optical board.

10. The apparatus of claim 1, wherein the blocking layer is formed on one surface of the optical board, and the one surface of the optical board is a surface on which the optical modulator is located.

11. The apparatus of claim 10, wherein the blocking layer being formed on the one surface of the optical board is formed by a semiconductor process.

12. The apparatus of claim 1, wherein the blocking layer is formed on the other surface of the optical board, and the other surface of the optical board is an opposite surface of where the optical modulator is located.

13. The apparatus of claim 12, wherein the blocking layer formed on the other surface of the optical board is formed after completing an optical module, and the optical module is a package completed by including the optical modulator on the optical board.

14. The apparatus of claim 13, wherein the blocking layer is non-reflective tape.

15. The apparatus of claim 12, wherein a hole passing through the optical board is formed at a location of the optical board corresponding to the optical modulator.

16. The apparatus of claim 15 further comprising a cover window, being located on the other surface of the optical board and covering the hole.

17. The apparatus of claim 16, wherein a phase mediating pattern is formed on a part of a surface of the cover window, the phase mediating pattern being a path of a beam of light incidenting or emitting to the optical modulator.

18. The apparatus of claim 17, wherein the phase mediating pattern is formed in relief and has a height of a compound barker code sequence pattern.

19. The apparatus of claim 17, wherein the phase mediating pattern is formed in intaglio and has a depth of a compound barker code sequence pattern.

20. The apparatus of claim 1, wherein the blocking layer is formed on an upper side and a lower side of the optical modulator located on the optical board.

21. The apparatus of claim 20, wherein the blocking layer is formed in a shape of a rectangle on the optical board.

22. The apparatus of claim 20, wherein the blocking layer is formed in a shape of peripheral type with an open center around the optical modulator on the optical board.
